(19) United States
(12) Patent Application Publication
(10) Pub. No.: US 2018/0029347 A1
(43) Pub. Date: Feb. 1, 2018

(54) Display Substrate And Methods For Attaching And Peeling Flexible Substrate Thereof

(71) Applicants: BOE TECHNOLOGY GROUP CO., LTD., Beijing (CN); BEIJING BOE DISPLAY TECHNOLOGY CO., LTD., Beijing (CN)

(72) Inventors: Jianguo XING, Beijing (CN); Jiazuo SAI, Beijing (CN); Juan YU, Beijing (CN); Feng WANG, Beijing (CN)

(21) Appl. No.: 15/521,753

(22) PCT Filed: Oct. 11, 2016
(86) PCT No.: PCT/CN2016/101766

§ 371 Date: Apr. 25, 2017

(30) Foreign Application Priority Data
Jan. 15, 2016 (CN) 201610027120.X

(51) Int. Cl. B32B 37/12; B32B 38/10; B32B 7/12; B32B 43/00; B32B 3/16

(52) U.S. Cl. CPC B32B 37/1284; B32B 43/006; B32B 3/16; B32B 7/12; B32B 38/10; B32B 2457/20; B32B 2307/208; B32B 2327/06; B32B 2367/00

(57) ABSTRACT

The present disclosure provides a display substrate and methods for attaching and peeling a flexible substrate thereof. The display substrate comprises a carrier substrate, a flexible substrate disposed on the carrier substrate, and an adhesive layer disposed between the carrier substrate and the flexible substrate. The adhesive layer comprises a magnetic viscous layer whose viscous strength is variable under an action of a magnetic field. One side of the adhesive layer contacted with the flexible substrate is provided with the magnetic viscous layer. Since the magnetic viscous layer whose viscous strength is variable under an action of a magnetic field is disposed on one side of the display substrate facing the flexible substrate, the flexible substrate can be attached and peeled during the manufacturing process just through a magnetic viscous layer under an action of a magnetic field. Further, the carrier substrate and the adhesive layer may be recycled.

The present application claims the priority of Chinese patent application No. 201610027120.X, filed on Jan. 15, 2016, the disclosure of which is hereby entirely incorporated by reference.

### TECHNICAL FIELD

Embodiments of the present disclosure relate to the technical field of substrate manufacture, and particularly, to a display substrate and methods for attaching and peeling a flexible substrate thereof.

### BACKGROUND

In recent years, flexible display as the focus of the next generation of display technology has been rapidly developed. The flexible display device employs a rollable and flexible substrate made of soft material. It is characterized by deformability and bendability. It has the advantages of being light and thin, convenient to carry, and so on.

At present, the manufacture of a flexible substrate is difficult, which seriously limits its applications and developments. Generally, a flexible substrate is fabricated by fixing it to a rigid carrier substrate. However, the attaching process for the flexible substrate is complex and it is difficult to peel off the fabricated flexible substrate. At present, there are many methods for fixing a flexible substrate to a carrier substrate. They can be generally classified into two types. For the first type, a flexible substrate is attached to a carrier substrate with an adhesive such as a double-sided adhesive tape. After the fabrication of the display device has been finished, the flexible substrate is peeled off. For the second type, the raw material of a flexible substrate is coated directly to a carrier substrate. After shaping the material, a flexible substrate is formed. Then, after the fabrication of the display device has been finished, the flexible substrate is peeled off. However, the above methods have the following defects. Firstly, if a flexible substrate is attached to a carrier substrate with an adhesive and peeled off after the fabrication of the display device has been finished, it is difficult to remove the fabricated flexible substrate from the carrier substrate, or there may exist adhesive residue. Secondly, if the raw material of a flexible substrate is directly coated to a carrier substrate and peeled off after the fabrication of the display device has been finished, it is difficult to fix the flexible substrate to the carrier substrate. Further, the method for coating the raw material and the method for peeling it have a high cost.

### SUMMARY

Embodiments of the present disclosure provide a display substrate and methods for attaching and peeling a flexible substrate thereof. Thereby, a flexible substrate can be attached and peeled during the manufacturing process just through a magnetic viscous layer under an action of a magnetic field. Further, the carrier substrate and the adhesive layer may be recycled.

According to an embodiment of the present disclosure, there is provided a display substrate comprising: a carrier substrate; a flexible substrate disposed on the carrier substrate; and an adhesive layer disposed between the carrier substrate and the flexible substrate. The adhesive layer comprises a magnetic viscous layer whose viscous strength is variable under an action of a magnetic field. One side of the adhesive layer contacted with the flexible substrate is provided with the magnetic viscous layer.

In a possible implementation, in the display substrate according to an embodiment of the present disclosure, the adhesive layer comprises a plurality of adhesive blocks spaced apart from each other.

In a possible implementation, in the display substrate according to an embodiment of the present disclosure, the adhesive layer further comprises a base and a binder. One side of the adhesive layer contacted with the carrier substrate is provided with the binder. The base is disposed between the magnetic viscous layer and the binder.

In a possible implementation, in the display substrate according to an embodiment of the present disclosure, the binder is a magnetic viscous layer.

In a possible implementation, in the display substrate according to an embodiment of the present disclosure, the magnetic viscous layer is switched between a liquid state and a plastomer state under the action of a magnetic field. A viscous strength of the magnetic viscous layer in the plastomer state is larger than a viscous strength of the magnetic viscous layer in the liquid state.

In a possible implementation, in the display substrate according to an embodiment of the present disclosure, the larger a strength of the magnetic field is, the larger the viscous strength of the magnetic viscous layer is.

In a possible implementation, in the display substrate according to an embodiment of the present disclosure, the magnetic viscous layer comprises ferromagnetic easily magnetized particles, a disperser and a stabilizer.

In a possible implementation, in the display substrate according to an embodiment of the present disclosure, the ferromagnetic easily magnetized particles are iron powders.

In a possible implementation, in the display substrate according to an embodiment of the present disclosure, the disperser is mineral oil, silicone oil or synthetic oil.

In a possible implementation, in the display substrate according to an embodiment of the present disclosure, the stabilizer is nano-scale HS1-type SiO₂.

In a possible implementation, in the display substrate according to an embodiment of the present disclosure, a material of the base is polyvinyl chloride, acryl, glass or polyester material.

According to an embodiment of the present disclosure, there is also provided a method for attaching a flexible substrate for the above display substrate. The method comprises attaching an adhesive layer to a carrier substrate, wherein the adhesive layer comprises a magnetic viscous layer whose viscous strength is variable under an action of a magnetic field. The method further comprises attaching the flexible substrate to the magnetic viscous layer. The method further comprises applying a magnetic field around the adhesive layer such that the flexible substrate is fixed to the carrier substrate through the adhesive layer.

In a possible implementation, in the above attaching method according to an embodiment of the present disclosure, attaching the adhesive layer to the carrier substrate comprises: attaching the adhesive layer to the carrier substrate through a binder in the adhesive layer.

In a possible implementation, in the above attaching method according to an embodiment of the present disclosure, the binder is a magnetic viscous layer.

In a possible implementation, in the above attaching method according to an embodiment of the present disclosure, after applying a magnetic field around the magnetic viscous layer, the magnetic viscous layer is switched from a liquid state to a plastomer state, wherein the viscous strength of the magnetic viscous layer in the plastomer state is larger than the viscous strength of the magnetic viscous layer in the liquid state.

According to an embodiment of the present disclosure, there is also provided a method for peeling a flexible substrate for the above display substrate. The method comprises: after fixing the flexible substrate to a carrier substrate through an adhesive layer, removing a magnetic field around the adhesive layer, wherein the adhesive layer comprises a magnetic viscous layer whose viscous strength is variable under an action of a magnetic field. The method further comprises: after removing the magnetic field, peeling the flexible substrate off from the magnetic viscous layer in the adhesive layer.

In a possible implementation, the above peeling method according to an embodiment of the present disclosure further comprises peeling the carrier substrate off from a binder in the adhesive layer.

In a possible implementation, in the above peeling method according to an embodiment of the present disclosure, the binder is a magnetic viscous layer.

In a possible implementation, in the above peeling method according to an embodiment of the present disclosure, after removing the magnetic field around the adhesive layer, the magnetic viscous layer is switched from a plastomer state to a liquid state, wherein the viscous strength of the magnetic viscous layer in the plastomer state is larger than the viscous strength of the magnetic viscous layer in the liquid state.

According to an embodiment of the present disclosure, there is also provided a display substrate comprising: a carrier substrate; a flexible substrate disposed on the carrier substrate; and an adhesive layer disposed between the carrier substrate and the flexible substrate. The adhesive layer comprises a magnetic viscous layer whose viscous strength is variable under an action of a magnetic field. One side of the adhesive layer contacted with the carrier substrate is provided with the magnetic viscous layer.

According to embodiments of the present disclosure, since the magnetic viscous layer whose viscous strength is variable under an action of a magnetic field is disposed on one side of the display substrate facing the flexible substrate, the flexible substrate can be attached and peeled during the manufacturing process just through a magnetic viscous layer under an action of a magnetic field. Further, the carrier substrate and the adhesive layer may be recycled.

### BRIEF DESCRIPTION OF THE DRAWINGS

In order to more clearly illustrate the technical solution of embodiments of the present disclosure, the drawings are simply introduced below. Apparently, the schematic structure diagrams in the following drawings are not necessarily drawn to scale, but exhibit various features in a simplified form. Moreover, the drawings in the following description relate merely to some embodiments of the present disclosure, and are not intended to limit the present disclosure.

FIG. 1 is a structure diagram of a display substrate according to an embodiment of the present disclosure;

FIG. 2 is a structure diagram of a display substrate according to another embodiment of the present disclosure;

FIG. 3 is a structure diagram of a display substrate according to yet another embodiment of the present disclosure;

FIG. 4 is a flowchart of a method for attaching a flexible substrate according to an embodiment of the present disclosure; and

FIG. 5 is a flowchart of a method for peeling a flexible substrate according to an embodiment of the present disclosure.

### DETAILED DESCRIPTION

In order to make the objectives, technical solutions and advantages of embodiments of the present disclosure apparent, the technical solutions of embodiments of the present disclosure will be described clearly and completely hereinafter in conjunction with the drawings. Apparently, embodiments described herein are merely a part of but not all embodiments of the present disclosure. Based on embodiments of the present disclosure described herein, those skilled in the art can obtain other embodiments without any creative work, which should be within the scope of the present disclosure.

In the description of the present disclosure, it should be noted that terms such as “up”, “down”, “top” and “bottom” indicates a directional or positional relationship that is based on what is shown in the drawings. They are used merely to conveniently describe the present disclosure and simplify the description, but not to indicate or imply that the corresponding devices or elements must have a specific directional relationship or be constructed or operated in a specific directional relationship. Thus, these terms should not be construed to limit the disclosure.

Hereinafter, a display substrate and methods for attaching and peeling a flexible substrate thereof according to embodiments of the present disclosure will be described in details with reference to the drawings.

The thicknesses and shapes of various layers in the drawings do not reflect the real scale of the display substrate. The purpose thereof is merely to illustrate embodiments of the present disclosure.

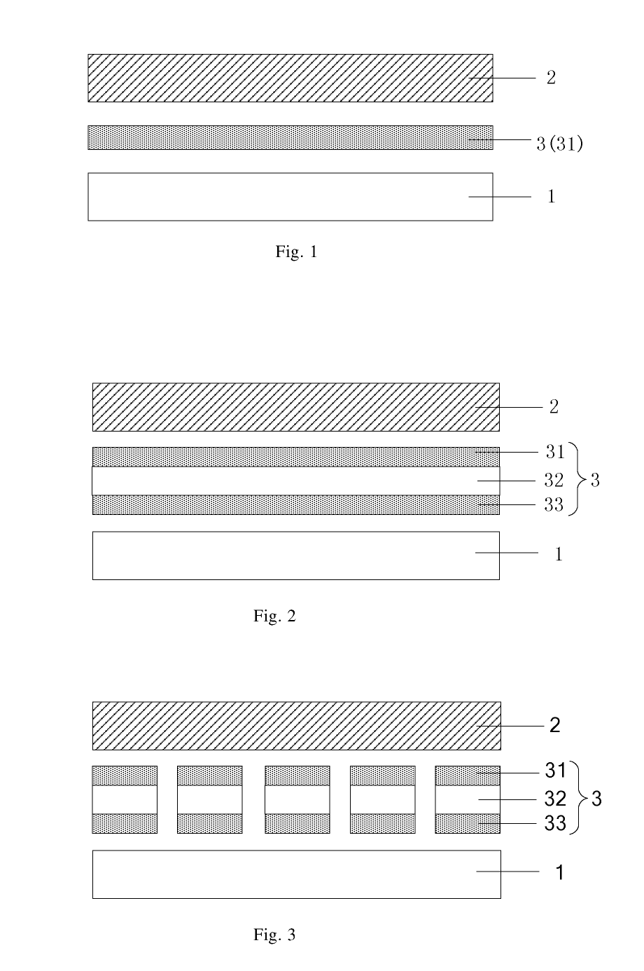

An embodiment of the present disclosure provides a display substrate. As shown in FIGS. 1 to 3, the display substrate comprises: a carrier substrate 1, which may be a rigid glass substrate; a flexible substrate 2 disposed on the carrier substrate 1; and an adhesive layer 3 disposed between the carrier substrate 1 and the flexible substrate 2. The adhesive layer 3 comprises a magnetic viscous layer 31 whose viscous strength is variable under an action of a magnetic field. One side of the adhesive layer 3 contacted with the flexible substrate 2 is provided with the magnetic viscous layer 31.

In the above display substrate according to the embodiment of the present disclosure, since the magnetic viscous layer whose viscous strength is variable under an action of a magnetic field is disposed on one side of the display substrate facing the flexible substrate, the flexible substrate can be attached and peeled during the manufacturing process just through a magnetic viscous layer under an action of a magnetic field. Further, the carrier substrate and the adhesive layer may be recycled.

In practice, in the display substrate according to an embodiment of the present disclosure, the magnetic viscous layer may be switched between a liquid state and a plastomer state under the action of a magnetic field. The viscous strength of the magnetic viscous layer in the plastomer state is larger than the viscous strength of the magnetic viscous layer in the liquid state. That is, the magnetic viscous layer can be switched between a suspension liquid with low viscosity and a viscous plastomer with high viscosity under the action of a magnetic field.

In practice, in the display substrate according to an embodiment of the present disclosure, the larger a strength of the magnetic field is, the larger the viscous strength of the magnetic viscous layer is. If no magnetic field is applied, i.e., the strength of the magnetic field is zero, the magnetic viscous layer is in the liquid state. After a magnetic field is applied, when the strength of the magnetic field is increased to a certain value, the magnetic viscous layer is switched from the liquid state into the plastomer state. With the increase of the strength of the magnetic field, the viscous strength gradually increases. Thus, the viscous strength of the magnetic viscous layer can be adjusted differently based on the strength of the magnetic field.

In practice, in the display substrate according to an embodiment of the present disclosure, as shown in FIG. 1, there is only one magnetic viscous layer 31 between the carrier substrate 1 and the flexible substrate 2. Since the magnetic viscous layer 31 has a good fluidity in the liquid state, it can be easily coated on the back or boundary region of the carrier substrate, thereby causing a contamination after the flexible substrate is attached. Thus, in order to prevent the flexible substrate from being contaminated, the adhesive layer may be provided as a three-layer structure. As shown in FIG. 2 (where the adhesive layer 3 comprises three layers arranged in a stack) and FIG. 3 (where the adhesive layer 3 comprises a plurality of adhesive blocks spaced apart from each other, each of which includes three layers arranged in a stack), the adhesive layer 3 may further comprise a base 32 and a binder 33. One side of the adhesive layer 3 contacted with the carrier substrate 1 is provided with the binder 33. The base 32 is disposed between the magnetic viscous layer 31 and the binder 33. Thus, the adhesive layer can be fabricated separately and then be attached directly to the carrier substrate, without the step of coating the magnetic viscous layer on the carrier substrate, thereby simplifying the manufacturing process and reducing the cost.

Further, in practice, in the display substrate according to an embodiment of the present disclosure, there are various types of binders. For example, the binder may be a double-sided adhesive tape. In this case, the adhesive layer and the carrier substrate may be recycled as a whole. The binder may also be a magnetic viscous layer. As shown in FIGS. 2 and 3, if the binder 33 is selected as a magnetic viscous layer whose viscous strength is variable under the action of a magnetic field, the carrier substrate can be separately recycled since the magnetic viscous liquid can be easily removed.

In practice, in the display substrate according to an embodiment of the present disclosure, the magnetic viscous layer is mainly composed of a magnetorheological fluid. The magnetorheological fluid is a kind of intelligent material. It shows a Newtonian fluid property with low viscosity under the condition of zero magnetic field. It shows a plastomer (Bingham body) property with high viscosity and a low fluidity under an action of a strong magnetic field. The magnetorheological fluid is a suspensoid formed by mixing soft magnetic small particles having high magnetic permeability and low hysteresis with a liquid with no magnetic permeability. At present, the commonly used magnetorheological fluid is a suspension liquid composed of three phases. The magnetorheological fluid is generally composed of a dispersed phase (e.g., ferromagnetic easily magnetized particles), a discrete phase (e.g., mineral oil, silicone oil and synthetic oil) and a stabilizer for improving the performance of the magnetorheological fluid. For example, the formula of the magnetorheological fluid used in an embodiment of the present disclosure is as follows: Dispersed phase particles: reduced hydroxy iron powders DT-50 with micron-size; Discrete phase: methyl silicone oil 201#; and

Stabilizer: HS1 type SiO₂ with nanometer scale and spherical shape.

The compositions of the magnetorheological fluid may be selected based on the actual situation. The present disclosure is not limited in this aspect.

In practice, in the display substrate according to an embodiment of the present disclosure, the following materials may be used as the base: Polyvinyl chloride (PVC), acrylic (also referred to as polymethyl methacrylate or PMMA), glass, or polyester material. Such materials can reduce the cost while avoiding the contamination to the substrate.

According to the same concept of invention, an embodiment of the present disclosure further provides a method for attaching a flexible substrate for the above display substrate. Since the principle of the method for solving the problem is similar to that of the above described display substrate, the method can be implemented as described above with respect to the display substrate. The repeated description is omitted here.

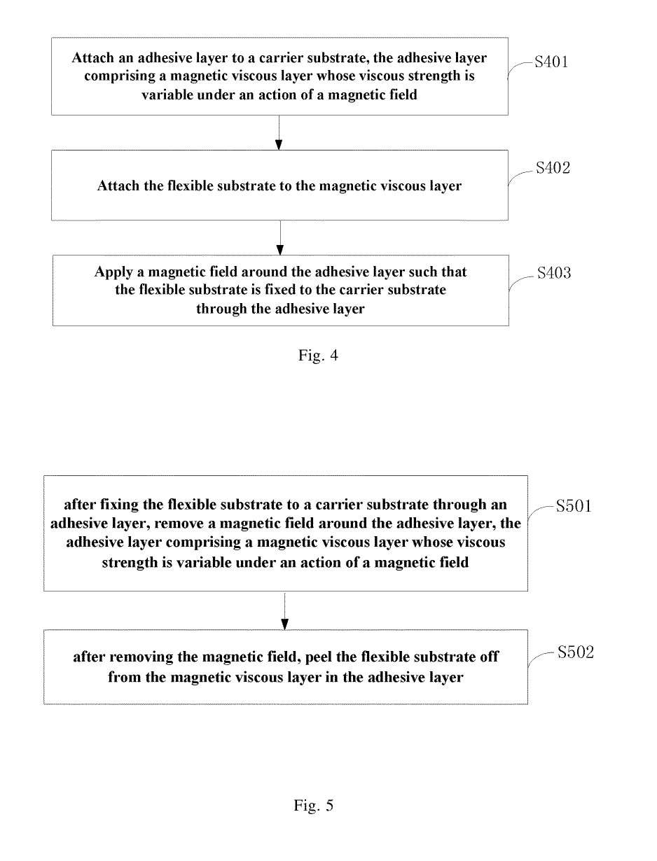

In practice, a method for attaching a flexible substrate for a display substrate according to an embodiment of the present disclosure comprises the following steps as shown in FIG. 4. At step S401, an adhesive layer is attached to a carrier substrate, wherein the adhesive layer comprising a magnetic viscous layer whose viscous strength is variable under an action of a magnetic field. At step S402, a flexible substrate is attached to the magnetic viscous layer. At step S403, a magnetic field is applied around the adhesive layer, such that the flexible substrate is fixed to the carrier substrate through the adhesive layer.

In the above attaching method of the flexible substrate according to an embodiment of the present disclosure, since the flexible substrate is attached to the magnetic viscous layer whose viscous strength is variable under the action of a magnetic field, the flexible substrate and the carrier substrate can be fixed together by adjusting the viscous strength of the magnetic viscous layer from low viscosity to high viscosity under the action of a magnetic field, such that the attaching method is simple and convenient.

In practice, in the attaching method of the flexible substrate according to an embodiment of the present disclosure, the step S401 of attaching the adhesive layer to the carrier substrate may be implemented by attaching the adhesive layer to the carrier substrate through a binder in the adhesive layer.

It should be noted that the adhesive layer may be fabricated separately and provided as a three-layer structure with binders on both sides and a base sandwiched between the binders. The binder on the side contacted with the flexible substrate may be provided as a magnetic viscous layer. The binder on the side contacted with the carrier substrate may be selected in a variety of ways. Thus, the adhesive layer can be directly attached to the carrier substrate without coating the magnetic viscous layer on the carrier substrate, thereby simplifying the manufacturing process and reducing the cost.

Further, in practice, in the attaching method of the flexible substrate according to an embodiment of the present disclosure, the binder on the side contacted with the carrier substrate may also be provided as a magnetic viscous layer. The carrier substrate can be separately recycled since the magnetic viscous liquid can be easily removed.

In practice, in the attaching method of the flexible substrate according to an embodiment of the present disclosure, after applying a magnetic field around the magnetic viscous layer, the magnetic viscous layer can be switched from a liquid state to a plastomer state, wherein a viscous strength of the magnetic viscous layer in the plastomer state is larger than a viscous strength of the magnetic viscous layer in the liquid state. At this time, under the action of a magnetic field, the magnetic viscous layer can be switched from a suspension liquid with low viscosity to a viscous plastomer with high viscosity, thereby fixing the flexible substrate and the glass substrate together.

According to the same concept of invention, an embodiment of the present disclosure further provides a method for peeling a flexible substrate for the above display substrate. Since the principle of the method for solving the problem is similar to that of the above described display substrate, the method can be implemented as described above with respect to the display substrate. The repeated description is omitted here.

In practice, a method for peeling a flexible substrate according to an embodiment of the present disclosure comprises the following steps as shown in FIG. 5. At step S501, after fixing a flexible substrate to a carrier substrate through an adhesive layer, a magnetic field around the adhesive layer is removed, wherein the adhesive layer comprises a magnetic viscous layer whose viscous strength is variable under an action of a magnetic field. At step S502, after removing the magnetic field, the flexible substrate is peeled off from the magnetic viscous layer in the adhesive layer.

In the above peeling method of the flexible substrate according to an embodiment of the present disclosure, since the viscosity of the magnetic viscous layer is changed from high viscosity to low viscosity after the magnetic field is removed, the flexible substrate can be peeled off, such that this method is simple and convenient. The flexible substrate will not be damaged when being peeled off, while the adhesive layer and the carrier substrate can be recycled. The magnetic viscous layer can be easily removed without causing any contaminations.

In practice, the peeling method of the flexible substrate according to an embodiment of the present disclosure may further comprise peeling the carrier substrate off from the binder in the adhesive layer.

Further, in practice, in the peeling method of the flexible substrate according to an embodiment of the present disclosure, if the binder contacted with the carrier substrate is selected as a magnetic viscous layer, it is convenient to peel off the carrier substrate since the viscosity of the magnetic viscous layer becomes low after the magnetic field is removed. Further, the carrier substrate can be recycled separately.

In practice, in the peeling method of the flexible substrate according to an embodiment of the present disclosure, after the magnetic field around the adhesive layer is removed, the magnetic viscous layer is switched from the plastomer state into the liquid state, wherein a viscous strength of the magnetic viscous layer in the plastomer state is larger than a viscous strength of the magnetic viscous layer in the liquid state. At this time, after the magnetic field is removed, the magnetic viscous layer is switched from a viscous plastomer with high viscosity to a suspension liquid with low viscosity, such that it is convenient to peel off the flexible substrate.

An embodiment of the present disclosure further provides a display substrate comprising: a carrier substrate; a flexible substrate disposed on the carrier substrate; and an adhesive layer disposed between the carrier substrate and the flexible substrate. The adhesive layer comprises a magnetic viscous layer whose viscous strength is variable under an action of a magnetic field. One side of the adhesive layer contacted with the carrier substrate is provided with the magnetic viscous layer.

In the display substrate according to an embodiment of the present disclosure, since the magnetic viscous layer whose viscous strength is variable under the action of a magnetic field is disposed on the side of the carrier substrate, the carrier substrate can be peeled off just through the magnetic viscous layer under the action of a magnetic field. Further, the carrier substrate can be recycled separately.

Based on the display substrate and methods for attaching and peeling a flexible substrate thereof according to embodiments of the present disclosure, since the magnetic viscous layer whose viscous strength is variable under an action of a magnetic field is disposed on one side of the display substrate facing the flexible substrate, the flexible substrate can be attached and peeled during the manufacturing process just through a magnetic viscous layer under an action of a magnetic field. Further, the carrier substrate and the adhesive layer may be recycled.

It should be noted that the embodiments described above are merely exemplary embodiments of the present disclosure, but are not used to limit the protection scope of the present disclosure. The protection scope of the present disclosure should be defined by the appended claims.

1. A display substrate comprising:
a carrier substrate;
a flexible substrate disposed on the carrier substrate; and
an adhesive layer disposed between the carrier substrate and the flexible substrate;
the adhesive layer comprises a magnetic viscous layer whose viscous strength is variable under an action of a magnetic field;
one side of the adhesive layer contacted with the flexible substrate is provided with the magnetic viscous layer.

2. The display substrate according to claim 1, wherein the adhesive layer comprises a plurality of adhesive blocks spaced apart from each other.

3. The display substrate according to claim 1, wherein the adhesive layer further comprises a base and a binder;
one side of the adhesive layer contacted with the carrier substrate is provided with the binder;
the base is disposed between the magnetic viscous layer and the binder.

4. The display substrate according to claim 3, wherein the binder is a magnetic viscous layer.

5. The display substrate according to claim 1, wherein the magnetic viscous layer is switched between a liquid state and a plastomer state under the action of a magnetic field;
a viscous strength of the magnetic viscous layer in the plastomer state is larger than a viscous strength of the magnetic viscous layer in the liquid state.

6. The display substrate according to claim 1, wherein the larger a strength of the magnetic field is, the larger the viscous strength of the magnetic viscous layer is.

7. The display substrate according to claim 1, wherein the magnetic viscous layer comprises ferromagnetic easily magnetized particles, a disperser and a stabilizer.

8. The display substrate according to claim 7, wherein the ferromagnetic easily magnetized particles are iron powders.

9. The display substrate according to claim 7, wherein the disperser is mineral oil, silicone oil or synthetic oil.

10. The display substrate according to claim 7, wherein the stabilizer is SiO₂.

11. The display substrate according to claim 3, wherein a material of the base is polyvinyl chloride, acryl, glass or polyester material.

12. A display substrate comprising:
a carrier substrate;
a flexible substrate disposed on the carrier substrate; and
an adhesive layer disposed between the carrier substrate and the flexible substrate;
the adhesive layer comprises a magnetic viscous layer whose viscous strength is variable under an action of a magnetic field;
one side of the adhesive layer contacted with the carrier substrate is provided with the magnetic viscous layer.

13. A method for attaching a flexible substrate for the display substrate according to claim 1, the method comprising:
attaching an adhesive layer to a carrier substrate, the adhesive layer comprising a magnetic viscous layer whose viscous strength is variable under an action of a magnetic field;
attaching the flexible substrate to the magnetic viscous layer; and
applying a magnetic field around the adhesive layer such that the flexible substrate is fixed to the carrier substrate through the adhesive layer.

14. The method according to claim 13, wherein attaching the adhesive layer to the carrier substrate comprises:
attaching the adhesive layer to the carrier substrate through a binder in the adhesive layer.

15. The method according to claim 14, wherein the binder is a magnetic viscous layer.

16. The method according to claim 13, wherein after applying a magnetic field around the magnetic viscous layer, the magnetic viscous layer is switched from a liquid state to a plastomer state, the viscous strength of the magnetic viscous layer in the plastomer state being larger than the viscous strength of the magnetic viscous layer in the liquid state.

17. A method for peeling a flexible substrate for the display substrate according to claim 1, the method comprising:
after fixing the flexible substrate to a carrier substrate through an adhesive layer, removing a magnetic field around the adhesive layer, the adhesive layer comprising a magnetic viscous layer whose viscous strength is variable under an action of a magnetic field; and
after removing the magnetic field, peeling the flexible substrate off from the magnetic viscous layer in the adhesive layer.

18. The method according to claim 17, further comprising:
peeling the carrier substrate off from a binder in the adhesive layer.

19. The method according to claim 18, wherein the binder is a magnetic viscous layer.

20. The method according to claim 17, wherein after removing the magnetic field around the adhesive layer, the magnetic viscous layer is switched from a plastomer state to a liquid state, the viscous strength of the magnetic viscous layer in the plastomer state being larger than the viscous strength of the magnetic viscous layer in the liquid state.
